(19) United States
(12) Patent Application Publication
(10) Pub. No.: US 2014/0110110 A1
(43) Pub. Date: Apr. 24, 2014

(54) Porous Proppants

(71) Applicant: Steve Rohring, Niagara Falls, NY (US)

(72) Inventor: Steve Rohring, Niagara Falls, NY (US)

(21) Appl. No.: 13/657,342

(22) Filed: Oct. 22, 2012

(51) Int. Cl. C09K 8/80; E21B 43/267

(52) U.S. Cl. CPC C09K 8/80; E21B 43/267
USPC 166/280.2; 507/269; 423/345; 428/402

(57) ABSTRACT

A lightweight proppant with high crush strength can include a ceramic such as silicon carbide or silicon nitride.

### CLAIM OF PRIORITY

This application claims priority to provisional U.S. application no. 61/549,878, titled “Porous Proppant,” and filed on Oct. 21, 2011, which is incorporated by reference in its entirety.

### TECHNICAL FIELD

This invention relates to porous proppants for use in hydraulic fracturing, and methods of making and using these.

### BACKGROUND

Hydraulic fracturing, or fracking, is a common stimulation technique used to enhance production of fluids from subterranean formations. In a typical hydraulic fracturing treatment, fracturing treatment fluid containing a proppant material is injected into the formation at a pressure sufficiently high enough to cause the formation or enlargement of fractures in the reservoir. Proppant material remains in the fracture after the treatment is completed, where it serves to hold the fracture open, thereby enhancing the ability of fluids to migrate from the formation to the well bore through the fracture.

Many different materials have been used as proppants including sand, glass beads, walnut hulls, and metal shot. Sand-based proppants are commonly used due to the low cost of sand. However, these proppants cannot often be used at depths where pressures are greater than about 2500 psi. The relatively recent rise of use of hydraulic fracturing, often referred to as fracking, has presented a need for proppants having increased crush strengths.

Many fracking wells are at depths greater than a few hundred feet and can subject proppant materials to pressures in excess of 10,000 psi. Therefore, strengthening coatings on sand and sintered ceramic proppants have been utilized to achieve greater crush strengths.

Two important properties of proppants are crush strength and density. High crush strength can be desirable for use in deeper fractures where pressures are greater, e.g., greater than about 2500 psi. As the relative strength of the various materials increases, so too have the respective particle densities. Proppants having higher densities can be more costly to use, for example due to transportation costs. Accordingly, there is a need for ultra-lightweight proppants having increased crush strength.

### SUMMARY

Ceramic ultra-lightweight porous proppants can be cost-effective for use in hydraulic fracturing operations. Silicon carbide and silicon nitride can advantageously provide a high degree of strength while having sufficient porosity to remain lightweight and facilitate fluid transport. Oxycarbides and oxynitrides of silicon are also suitable lightweight proppant materials.

In one aspect, a porous proppant has a generally spherical shape with a particle diameter between 100 and 2,000 microns, median pore sizes between 1 and 50 microns, and a porosity between 10 and 70% of the total spherical volume.

For a plurality of porous proppants, each porous proppant individually can form a proppant pack that has a crush strength of at least 2,000 psi and an apparent specific gravity of 1.0 g/cc or less; a crush strength of at least 4,000 psi and an apparent specific gravity of 1.3 g/cc or less; a crush strength of at least 6,000 psi and an apparent specific gravity of 1.6 g/cc or less; a crush strength of at least 8,000 psi and an apparent specific gravity of 1.8 g/cc or less; a crush strength of at least 10,000 psi and an apparent specific gravity of 2.0 g/cc or less; or a crush strength of at least 12,000 psi and an apparent specific gravity of 2.2 g/cc or less.

For a plurality of porous proppants, each porous proppant individually can form a proppant pack that produces 10% or less fines in a crush test.

The porous particles can include silicon carbide, silicon nitride, or a combination thereof. The porous particles can include 90% or greater silicon carbide. The porous particles can have a sphericity of 0.91 or greater, or 0.95 or greater. The porous particles can have a roundness of 0.91 or greater, or 0.95 or greater.

In another aspect, a composition includes a plurality of particles including silicon carbide, silicon nitride, or a combination thereof, forming a porous proppant having a generally spherical shape with a particle diameter between 100 and 2,000 microns, median pore sizes between 1 and 50 microns, and a porosity between 10 and 70% of the total spherical volume.

For a plurality of compositions, each porous proppant individually can form a proppant pack that has a crush strength of at least 2,000 psi and an apparent specific gravity of 1.0 g/cc or less; a crush strength of at least 4,000 psi and an apparent specific gravity of 1.3 g/cc or less; a crush strength of at least 6,000 psi and an apparent specific gravity of 1.6 g/cc or less; a crush strength of at least 8,000 psi and an apparent specific gravity of 1.8 g/cc or less; a crush strength of at least 10,000 psi and a an apparent specific gravity of 2.0 g/cc or less; or a crush strength of at least 12,000 psi and an apparent specific gravity of 2.2 g/cc or less.

For a plurality of compositions, each porous proppant individually can form a proppant pack that produces 10% or less fines in a crush test.

In the composition, particles can have a sphericity of 0.91 or greater, or 0.95 or greater. The particles can have a roundness of 0.91 or greater, or 0.95 or greater.

In another aspect, a method of using a composition of claim 15, comprising injecting the composition into a hydrofracture.

In another aspect, a method of making a porous proppant, includes heating a composition including a carbon source and a silicon source between 10 and 70% porosity of the total proppant volume thereby forming a porous silicon carbide proppant.

The porous silicon carbide proppant can have a particle diameter between 100 and 2,000 microns, median pore sizes between 1 and 50 microns, and a porosity between 10 and 70% of the total spherical volume.

Other aspects, embodiments, and features will be apparent from the following description, the drawings, and the claims.

### BRIEF DESCRIPTION OF THE DRAWINGS

FIGS. 1-2 are SEM images of a porous proppant.

FIGS. 3A-3B show results of short term conductivity and permeability testing of porous proppants.

FIGS. 4A-4B show results of long term conductivity and permeability testing of a porous proppant.

### DETAILED DESCRIPTION

Two important physical attributes of proppant packs—pack strength and pack porosity—depend on many factors. Proppant density is also an important attribute. These three important attributes strongly influence overall performance of well conductivity. Although there are many factors that determine compressive strength, porosity and density to achieve overall conductivity, they can be categorized into four levels of importance.

The first and most important level (the goal) is conductivity. This determines the performance of the well. Permeability and other related flow terminology is associated with conductivity. It is well known that strength and porosity of the proppant pack are primary factors in determining conductivity. Accordingly, proppants providing enhanced well performance, e.g., proppants having increased strength and/or porosity, are desirable.

The second level of importance is combined strength and porosity. A proppant pack must be strong in compression and not produce fines that will plug the pores of the proppant pack in the well. When proppants are crushed they produce small fractions called fines that can reduce well performance. Therefore strong, porous proppant packs are most desirable for conductivity.

A third level of importance is proppant density. Although density does not affect conductivity once a proppant pack is in place, a less dense proppant can be delivered further into the well before settling. Lighter proppants flow with water, brine or other fluid mediums to allow deeper penetration into the well.

Fourth-level attributes that contribute to higher level important attributes include, but are not limited to: primary material composition; secondary material composition; necking size of primary material composite grains with itself or secondary composition; sintered grain size of primary material composition; porosity volume—total volume in the proppant; pore size; pore shape; open vs. closed pores; sphericity/roundness; proppant particle size (e.g., sphere diameter); proppant particle size distribution; nature of size distribution (e.g., bi-modal, single mode size distribution, or other).

While many variables determine overall performance, the combined properties of strength and porosity most heavily influence conductivity. A desirable proppant is one that has low density yet high compressive strength.

The failure mode of proppant packs typically involves fracturing of individual proppants, under well formation pressure, thus producing smaller proppant particles (fines). The plugging failure mode results from fines produced from proppant crushing yielding in poorer conductivity when more fines are produced.

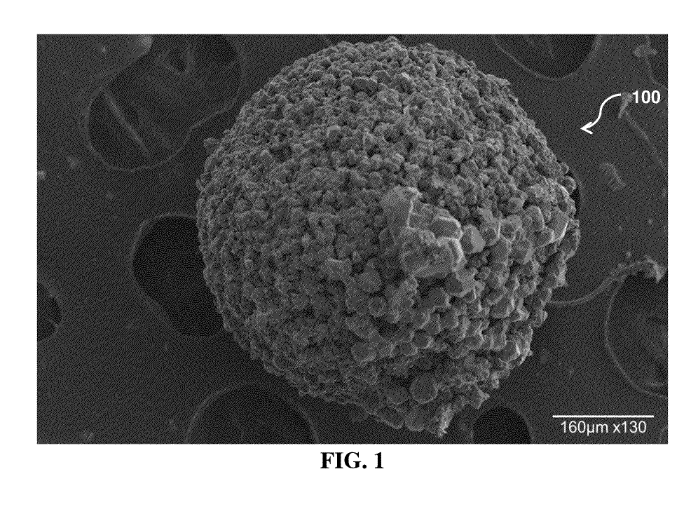

With reference to FIG. 1, a porous proppant is indicated generally by numeral 100. Porous proppant 100 can be generally spherical, ovoid, elongate, columnar, or other shape, including an irregular shape. For example, the porous proppant can be spherical and have a Krumbein sphericity of at least about 0.5, at least 0.6 or at least 0.7, at least 0.8, or at least 0.9, and/or a roundness of at least 0.4, at least 0.5, at least 0.6, at least 0.7, at least 0.8, or at least 0.9. The term “spherical” can refer to roundness and sphericity on the Krumbein and Sloss Chart by visually grading 10 to 20 randomly selected particles. Sphericity and roundness of at least 0.9 is most desired to achieve higher strength at lower densities.

Porous proppant 100 can be formed of any suitable oxide, carbide, or nitride of silicon, boron, aluminum, zirconium, iron, titanium, zinc, tin, chromium, manganese, magnesium or calcium. For example, the porous proppant can be formed of a silicon carbide, a silicon nitride, a silicon oxide, an aluminum oxide, a boron carbide, or a combination thereof. In some cases, porous proppant 100 can be composed of at least 90% silicon carbide, at least 95% silicon carbide, at least 98% silicon carbide, or at least 99% silicon carbide. In some cases, porous proppant 100 can be composed of at least 90% silicon nitride, at least 95% silicon nitride, at least 98% silicon nitride, or at least 99% silicon nitride. Porous proppant 100 can have a diameter ranging from about 1 micron to about 3,000 microns, e.g., between about 100 and 2,000 microns. In some embodiments, porous proppant 100 has a diameter of about 500 microns.

The median pore sizes of the porous proppant can be between, e.g., about 1 micron and about 50 microns, and the porosity can account for about 10% to about 70% of the total spherical volume. The pore sizes can be tailored in size and volume to achieve different crush strengths for different well formations.

The porous proppant can have a crush strength greater than 10,000 psi with a specific gravity of less than 2.2 g/cc. The porous proppant can have a crush strength greater than 11,000 psi, greater than 12,000 psi, or higher. The porous proppant can have a specific gravity of less than 2.0 g/cc, less than 1.8 g/cc, less than 1.6 g/cc, less than 1.5 g/cc, or less than 1.4 g/cc, or lower. The porous proppant desirably combines properties of high crush strength and low density. For example, the porous proppant can have a crush strength greater than 10,000 psi with a specific gravity of less than 2.2 g/cc; a crush strength greater than 11,000 psi with a specific gravity of less than 2.0 g/cc; a crush strength greater than 12,000 psi with a specific gravity of less than 1.8 g/cc; or even higher crush strengths combined with even lower specific gravities.

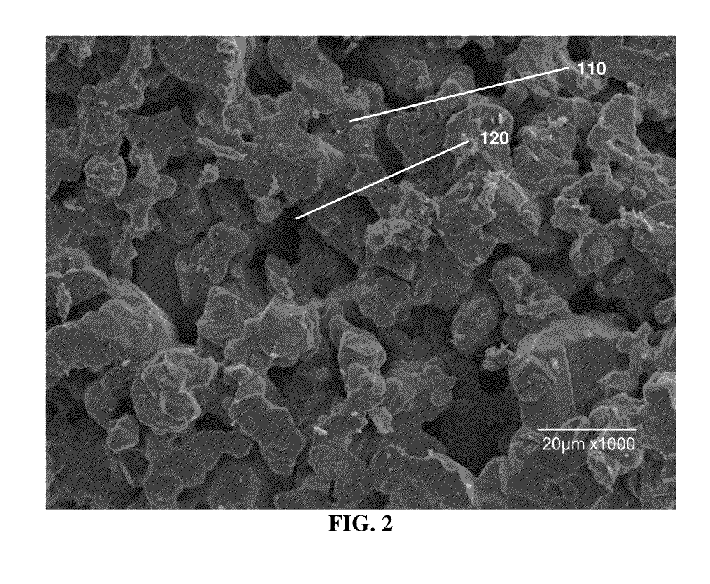

FIG. 2 shows a proppant at greater magnification than FIG. 1. Porous proppant 100 has a scaffold 110 forming heterogeneous pores 120. The truss structure of scaffold 110 imparts increased strength to proppant 100 so that the proppant can withstand crush strengths greater than 12,000 psi. Moreover, pores 120 provide permeability so that, once injected into a hydrofracture, released fluid can pass through the pores of the proppant as well as around the spaces formed by the packing of the particles. Non-porous proppants, or those proppants modified with external surface treatments, are limited in fluid extraction as fluid can only pass through the tortuous path created by the packing of the particles. Thus, porous proppants can greatly increase the amount of fluid extracted and also extracts the fluid more quickly than proppants used currently.

Porous proppant 100 can be formed by reducing silica- and carbon-based materials, e.g., to provide a silicon carbide porous proppant. In one embodiment, a carbon source is reacted with a silicon source to form a porous silicon carbide by controlling the reaction to prevent densification. Alternatively, the pores can be formed during a sintering process. Templating approaches can also be used to form pores.

A suitable carbon source can be derived from coal. Other suitable carbon sources of include graphite or carbon black.

In some embodiments, a carbon source is combined with a silicon source (such as a silicon dioxide, e.g., silica, or sand) and reduced in the presence of reducing agents to produce silicon carbide. Porosity resulting from the off-gassing of the oxygen can impart porosity to the resulting silicon carbide. Silicon carbide powder can also be pressureless sintered to produce porous proppants. Reaction bonding is another process that can be utilized to produce porous proppants. Any suitable method to process a solid material into spherical particles can be used, such as e.g., milling, spray drying, spheronization, encapsulation, granulation or extruding. In most embodiments, spherical particles are desirable. For example, the porous non-sintered source can have a Krumbien sphericity of 0.8 or higher, 0.9 or higher, 0.95 or higher, 0.98 or higher, or 0.99 or higher.

Sintering can be carried out using any suitable method of heating a silicon carbide source, or a carbon source and a silicon source, including, for example, resistance, radiation, convection, induction, plasma, laser, microwave, or other methods. Additional sintering aids may optionally be included, such as a polymeric binder or organic binders. The extent of sintering can be controlled by adjusting the temperature and duration. In a first phase of forming a porous proppant, a reduction step of a carbon source and a silicon dioxide produces a porous silicon carbide. Thus, a carbon source of particulate carbon can produce particulate porous silicon carbide. In an optional second phase of forming a porous proppant, sintering particles of the particulate porous silicon carbide can produce a controllable degree of fusion. Thus, “necking” can occur between particles of porous silicon carbide, i.e., the formation of bridges joining particles of porous silicon carbide. The bridges thus formed are desirably composed of silicon carbide, rather than a silicon oxide, which would result in a weaker proppant than similar material with bridges composed of silicon carbide. Amounts of less than 10% of oxides are preferable in the necking regions (e.g., oxides such as silicon oxide, alumina, zirconia, glass, mullite, and other clay bonding) can be acceptable, whereas 90% or more of the porous proppant is composed of silicon carbide or silicon nitride. Boron carbide and boron nitride also are acceptable in the necking region at levels of less than 10%. Preferably silicon carbide is bonded to silicon carbide as the necking region.

The necking process can form a structure having an additional level of porosity, i.e., the porosity formed between particles that are joined by bridges. Thus the resulting material can have a larger-scale porosity (e.g., on the order of one micron to fifty microns) between particles; and smaller-scale porosity (e.g., on the order of less than one micron to ten microns). Control over this larger-scale porosity can be achieved by controlling the degree of fusion between particles. Higher temperatures and increased time promotes a higher degree of fusion. When fused to a higher degree, the bridges between particles become larger and more numerous; individual particles become less distinct and more agglomerated.

Fines of less than 10% can be generally acceptable in crush tests. 90% or greater original particle sizes must be retained in the sieve during a crush test procedure. Crush tests are not a substitute for conductivity or actual well performance but are a suitable gauge of proppant performance, and for comparisons of different proppant materials.

Flow back is another issue that can result in poor well conductivity performance. The strength of the proppant pack is not only determined by the compressive strength of the proppants but also how well they stay in the pack. Lower density proppants can have negative flow back issues, so traditional coatings (resins) can be used on the porous proppants mentioned herein to reduce or prevent flow back issues.

Proppants randomly packed (similar to bulk density packing methods) yield in greater than 30% volume to less than 70% volume of the proppant porous packs. However, this does not include the porosity of the proppant itself as it only includes the porous volume in the pack between the proppants.

Many attributes and variables determine the porous volume of a proppant pack such as packing method, particle size, particle shape and particle distribution. However, these properties combine to form a total pack porosity that determines ultimate conductivity in conjunction with pack strength.

Specific gravity is the density of the material and is also defined as the skeletal density of the porous proppant. The apparent specific gravity is the adjusted density of the proppant when considering the addition of the pore density with the proppant material density.

For example, silicon carbide may have a specific gravity of 3.2 g/cc yet the proppant may have an apparent specific gravity of 1.6 g/cc when considering 50% porosity volume. The term ‘density’ of the proppant herein refers to the apparent specific gravity, not bulk density or any other density term that may be used elsewhere.

Sphericity and roundness of at least 0.9 is most desired to achieve higher strength at lower densities.

Suitable proppant particle sizes in many cases are 20/40 mesh. However other mesh sizes can realize similar results of strength and density attributes.

A mesh size range is determined by retaining all proppant particles in the smaller mesh screen (such as 40 mesh) and allowing all other proppant particles to pass through the larger mesh screen (such as 20 mesh).

The following discussion provides an example of the relationship between dense proppant strength and porous pack strength.

Solid silicon carbide having a proppant strength of 540,000 psi can yield 180,000 psi for a single solid sphere, then yielding 60,000 psi for a porous proppant pack of non-porous (dense) spheres. The result can less than 10% fines after crush testing.

Solid spheres made from silicon carbide can be ‘overkill’ for most rock formations so porous silicon carbide yields a strong, light weight solution compared to sand and sintered ceramics. Starting with higher levels of compressive strength allow porous silicon carbide provide similar strength levels as sand and ceramics, yet at more desirable lower densities.

The following discussion provides an example of porous proppant strength in relation to porous pack strength.

Given 60,000 psi for 60% porous block, yielding 20,000 psi for a single 60% porous sphere, then yielding 6,000 psi for a 50% porous proppant pack consisting of 60% porous spheres.

Table 1 below shows that silicon carbide has desirable for a lightweight proppant. Boron carbide can also be a good choice for proppants, but may be cost prohibitive. Only widely available raw materials such as sand, certain clays, carbon, and forms of aluminosilicates are acceptable in terms of cost. Conversion of sand and carbon into porous silicon carbide is a preferred embodiment for low cost, high strength, low density proppants.

TABLE 1

| Proppant | Compressive | Density | Strength to |
|---|---|---|---|
| Material | Strength (psi) | (gram/cc) | Density Ratio |
| silica | 165,343 | 2.6 | 63,593 |
| mullite | 188,549 | 2.8 | 67,339 |
| alumina | 377,098 | 3.8 | 99,236 |
| boron carbide | 415,442 | 2.5 | 166,177 |
| silicon carbide | 565,647 | 3.2 | 176,765 |
| | | | (Compressive |
| | | | Strength per g) |

### EXAMPLES

### Example 1

### Short Term Conductivity and Permeability

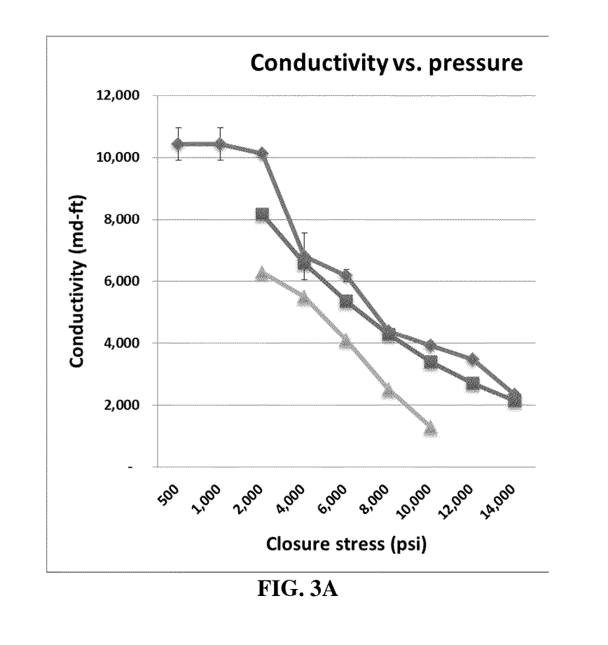

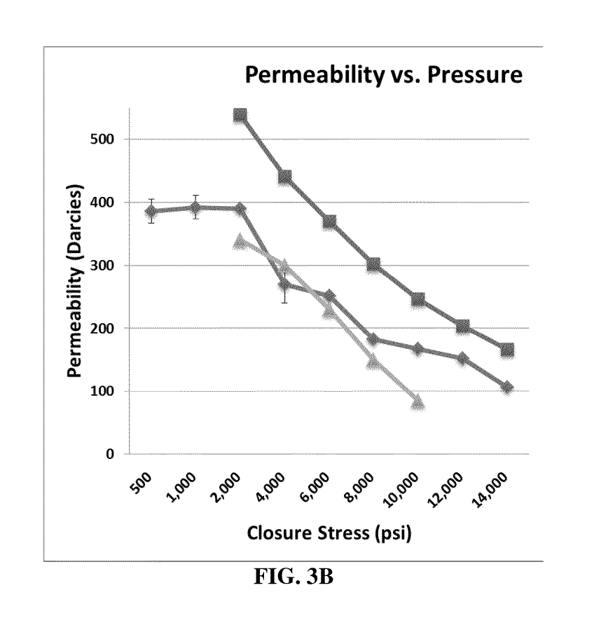

FIG. 3A shows the results of a short term conductivity test using a silicon carbide proppant (diamonds), a commercial sintered bauxite proppant (squares), and a commercial mixed aluminum oxide/silicon oxide proppant (triangles). FIG. 3B shows the results of short term permeability tests for the same materials.

### Example 2

### Long Term Conductivity and Permeability

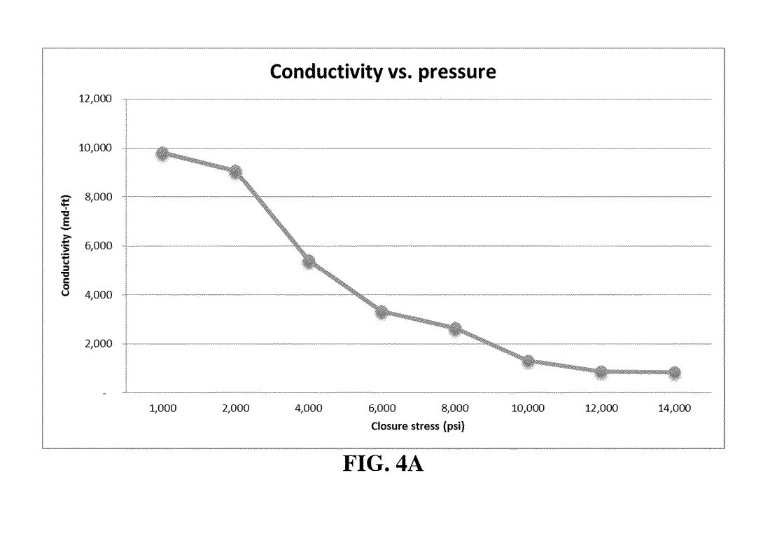

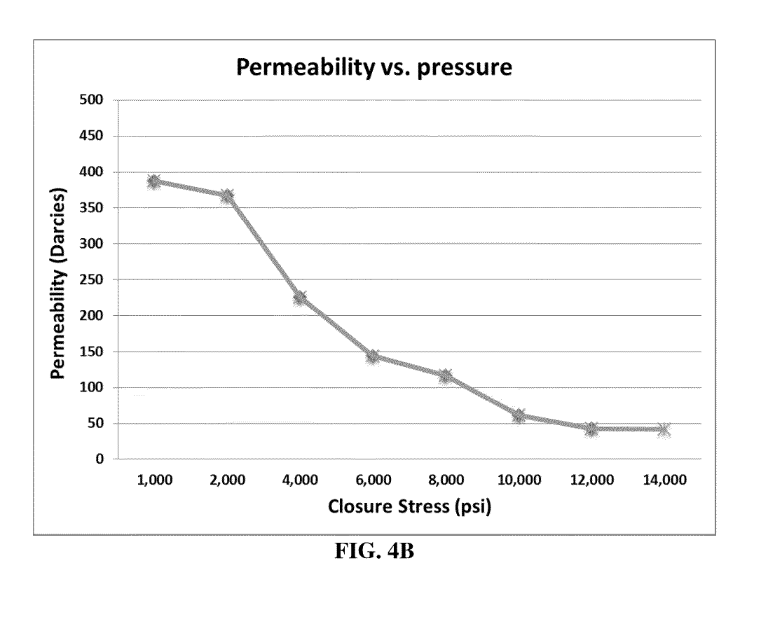

FIG. 4A shows the results of a long term conductivity test using a silicon carbide proppant; FIG. 4B shows the results of a long term permeability test using the same material.

### Example 3

### Strength Measurements

| | Compressive | Density | % Fines | Mesh |
|---|---|---|---|---|
| Porous Proppant Grade | Strength (psi) | (gram/cc) | Generated | Size |
| 99% SiC w/1% oxide | 5,000 | 1.4 | 9% | 30 |
| 90% SiC w/10% mullite | 8,000 | 1.6 | 7% | 20/40 |
| 99% SiC w/1% oxide | 10,000 | 1.8 | 6% | 30 |
| 98% SiC w/2% oxide | 12,000 | 2.2 | 9% | 20/40 |

Other embodiments are within the scope of the following claims.

What is claimed is:

1. A porous proppant having a generally spherical shape with a particle diameter between 100 and 2,000 microns, median pore sizes between 1 and 50 microns, and a porosity between 10 and 70% of the total spherical volume.

2. A plurality of porous proppants of claim 1, wherein each porous proppant individually forms a proppant pack that has a crush strength of at least 2,000 psi and an apparent specific gravity of 1.0 g/cc or less.

3. A plurality of porous proppants of claim 1, wherein each porous proppant individually forms a proppant pack that has a crush strength of at least 4,000 psi and an apparent specific gravity of 1.3 g/cc or less.

4. A plurality of porous proppants of claim 1, wherein each porous proppant individually forms a proppant pack that has a crush strength of at least 6,000 psi and an apparent specific gravity of 1.6 g/cc or less.

5. A plurality of porous proppants of claim 1, wherein each porous proppant individually forms a proppant pack that has a crush strength of at least 8,000 psi and an apparent specific gravity of 1.8 g/cc or less.

6. A plurality of porous proppants of claim 1, wherein each porous proppant individually forms a proppant pack that has a crush strength of at least 10,000 psi and an apparent specific gravity of 2.0 g/cc or less.

7. A plurality of porous proppants of claim 1, wherein each porous proppant individually forms a proppant pack that has a crush strength of at least 12,000 psi and an apparent specific gravity of 2.2 g/cc or less.

8. A plurality of porous proppants of claim 1, wherein each porous proppant individually forms a proppant pack that produces 10% or less fines in a crush test.

9. The porous proppant of claim 1, wherein the porous particles include silicon carbide, silicon nitride, or a combination thereof.

10. The porous proppant of claim 9, wherein the porous particles include 90% or greater silicon carbide.

11. The porous proppant of claim 1, wherein the porous particles have a sphericity of 0.91 or greater.

12. The porous proppant of claim 1, wherein the porous particles have a roundness of 0.91 or greater.

13. The porous proppant of claim 1, wherein the porous particles have a sphericity of 0.95 or greater.

14. The porous proppant of claim 1, wherein the porous particles have a roundness of 0.95 or greater.

15. A composition comprising a plurality of particles including silicon carbide, silicon nitride, or a combination thereof, forming a porous proppant having a generally spherical shape with a particle diameter between 100 and 2,000 microns, median pore sizes between 1 and 50 microns, and a porosity between 10 and 70% of the total spherical volume.

16. A plurality of compositions of claim 15, wherein each porous proppant individually forms a proppant pack that has a crush strength of at least 2,000 psi and an apparent specific gravity of 1.0 g/cc or less.

17. A plurality of compositions of claim 15, wherein each porous proppant individually forms a proppant pack that has a crush strength of at least 4,000 psi and an apparent specific gravity of 1.3 g/cc or less.

18. A plurality of compositions of claim 15, wherein each porous proppant individually forms a proppant pack that has a crush strength of at least 6,000 psi and an apparent specific gravity of 1.6 g/cc or less.

19. A plurality of compositions of claim 15, wherein each porous proppant individually forms a proppant pack that has a crush strength of at least 8,000 psi and an apparent specific gravity of 1.8 g/cc or less.

20. A plurality of compositions of claim 15, wherein each porous proppant individually forms a proppant pack that has a crush strength of at least 10,000 psi and a an apparent specific gravity of 2.0 g/cc or less.

21. A plurality of compositions of claim 15, wherein each porous proppant individually forms a proppant pack that has a crush strength of at least 12,000 psi and an apparent specific gravity of 2.2 g/cc or less.

22. The composition of claim 15, wherein each porous proppant individually forms a proppant pack that produces 10% or less fines in a crush test.

23. A method of using a composition of claim 15, comprising injecting the composition into a hydrofracture.

24. The composition of claim 15, wherein the particles have a sphericity of 0.91 or greater.

25. The composition of claim 15, wherein the particles have a roundness of 0.91 or greater.

26. The composition of claim 15, wherein the particles have a sphericity of 0.95 or greater.

27. The composition of claim 15, wherein the particles have a roundness of 0.95 or greater.

28. A method of making a porous proppant, comprising heating a composition including a carbon source and a silicon source between 10 and 70% porosity of the total proppant volume thereby forming a porous silicon carbide proppant.

29. The method of claim 24, wherein the porous silicon carbide proppant has a particle diameter between 100 and 2,000 microns, median pore sizes between 1 and 50 microns, and a porosity between 10 and 70% of the total spherical volume.
